(19) United States
(12) Patent Application Publication
(10) Pub. No.: US 2004/0238069 A1
(43) Pub. Date: Dec. 2, 2004

(54) Multifunctional carpentry apparatus

(76) Inventor: Cai Bai He, N. Miami Beach, FL (US)

Correspondence Address: GOLD & RIZVI, P.A., 600 N. PINE ISLAND ROAD, SUITE 450, PLANTATION, FL, 33324-1311, US

(21) Appl. No.: 10/869,266

(22) Filed: Jun. 16, 2004

Related U.S. Application Data
(63) Continuation-in-part of application No. 10/306,090, filed on Nov. 27, 2002, now abandoned.

(51) Int. Cl. B27C 9/00; B26D 1/14; B23D 19/00

(52) U.S. Cl. 144/35.1; 144/1.1; 144/39; 83/581; 83/477.1

(57) ABSTRACT

A multifunctional electrically powered and operated construction apparatus incorporating an electric saw tool, an electric planer tool, and an electric drill tool all mounted upon a common stock pillar of the apparatus. The apparatus incorporates a unique system of cooperating transmission and gear subassemblies that enable an operator of the apparatus to quickly and efficiently adjust the apparatus to toggle between sawing, drilling and planning functions.

### CROSS-REFERENCE TO RELATED APPLICATIONS

This application is a continuation-in-part of co-pending U.S. patent application Ser. No. 10/306,090, entitled MULTIFUNCTIONAL COMBINED PROCESSING MACHINERY FOR CARPENTRY, filed on Nov. 22, 2002 by the same inventor, the entire specification of which is incorporated herein by reference.

### BACKGROUND OF THE INVENTION

1. Field of the Invention

The present invention relates generally to electric powered equipment and, more particularly, to a multifunctional electrical construction apparatus incorporating an electric saw tool, an electric planer tool, and an electric drill tool, all mounted upon a common stock pillar and cooperating through a system of transmissions and gears to enable an operator to quickly and efficiently alternate between operation of the tools.

2. Description of the Prior Art

In the field of construction, and particularly carpentry, it is common that a particular job or project requires the use of multiple different electrically operated tools. For example, carpenters will commonly use an electric saw to cut wood, an electric drill to bore holes in wood, and an electric planer tool to process the surface of wood. Oftentimes, such carpentry work is performed indoors where there is limited space available for such equipment. Furthermore, the need to constantly move a work piece from one piece of equipment to another piece of equipment often adds considerably to processing times.

Accordingly, the present invention seeks to overcome the drawbacks, disadvantages and limitations discussed above by providing a single apparatus combining the functions of an electric planer tool, an electric saw and an electric drill.

### SUMMARY OF THE INVENTION

The present invention is generally directed to a multifunctional electrically powered and operated construction apparatus incorporating an electric saw tool, an electric planer tool, and an electric drill tool all mounted upon a common stock pillar of the apparatus. The apparatus incorporates a unique system of cooperating transmission and gear subassemblies that enable an operator of the apparatus to quickly and efficiently adjust the apparatus to toggle between sawing, drilling and planning functions.

In one general aspect of the present invention, a multifunctional electrically powered construction apparatus is provided, comprising:

a stock having an upward standing pillar extending therefrom;

an electric saw mounted upon said stock pillar;

an electric drill mounted upon said stock pillar;

an electric planer mounted upon said stock pillar; and

a cooperating system of gears and transmissions,

wherein, said cooperating system of gears and transmissions enable an operator of said apparatus to selectively toggle between operation of said saw, said drill and said planer.

In another aspect of the invention, the apparatus includes a function adjustment cord having a first end in engagement with the upward standing pillar of the stock and an opposite second end in engagement with a function adjustment fork. Resent springs are provided between a function adjustment gearbox, or housing, and the shift fork. Function adjusting gears are preferably provided within a main axle of the apparatus, and the function adjusting shift fork is inserted into a fork groove of the function adjusting gears. In this manner, the function adjusting shift fork is able to bias the function adjusting gear such that it slides along the main axle of the apparatus for engagement with transmission gears associated with each of the aforementioned electrical tools.

In another aspect of the invention, the apparatus further includes movable, or shifting, rotary sleeves. By virtue of the combined functions of the upward standing pillar of the stock, rotary sleeves, reset springs and cord components, the function adjusting shift fork can bias the function adjusting gear for sliding along the main axle of the apparatus for engagement with the tool transmission gears.

Accordingly, the apparatus of the present invention provides a relatively compact multifunctional construction apparatus combining the functions of multiple commonly used construction tools, wherein the different tools are all mounted upon a common stock pillar of the apparatus and cooperate in such a manner as to enable an operator of the apparatus to quickly and efficiently alternate between use of the different tool functions.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a perspective view of the multifunctional construction tool apparatus of the present invention, wherein the apparatus is oriented for using the electric saw component thereof;

FIG. 2 is a rear perspective view of the apparatus of FIG. 1, illustrating the cooperation of various subcomponents of the apparatus during operation of the electric saw component;

FIG. 2a is a magnified view of the function adjusting shift fork and function adjusting gear components of FIG. 2;

FIG. 3 is a perspective view of the multifunctional construction tool apparatus of the present invention, wherein the apparatus is oriented for using the electric planer component thereof;

FIG. 4 is a rear perspective view of the apparatus of FIG. 3, illustrating the cooperation of various subcomponents of the apparatus during operation of the electric planer component;

FIG. 5 is a rear perspective view illustrating the installation of the electric planer tool of the present invention;

FIG. 6 is a perspective view of the multifunctional construction tool apparatus of the present invention, wherein the apparatus is oriented for using the electric drill component thereof; and

FIG. 7 is a rear perspective view of the apparatus of FIG. 6, illustrating the cooperation of various subcomponents of the apparatus during operation of the electric drill component.

### DETAILED DESCRIPTION OF THE PREFERRED EMBODIMENTS

Shown throughout the figures, the present invention is generally directed to a multifunctional electrically powered and operated construction apparatus incorporating an electric saw tool, an electric planer tool, and an electric drill tool all mounted upon a common stock pillar of the apparatus. The apparatus incorporates a unique system of cooperating transmission and gear subassemblies that enable an operator of the apparatus to quickly and efficiently adjust the apparatus to toggle between sawing, drilling and planning functions.

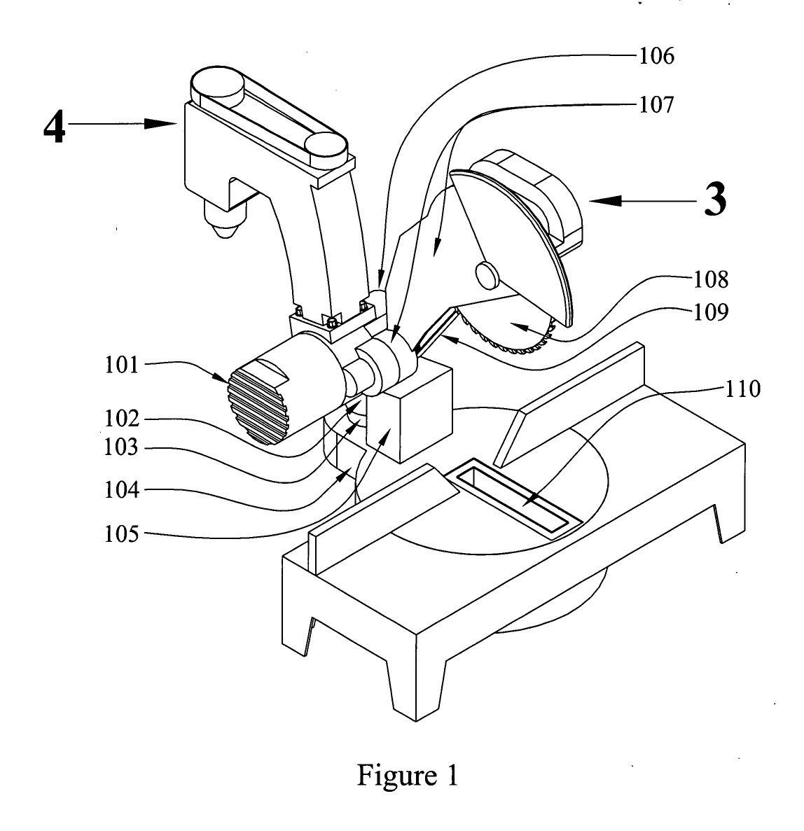

Referring initially to FIGS. 1-3, a stock 104 is provided having mounted thereon a plurality of electrical construction, or carpentry, tools including an electric planer tool 2, an electric saw 3, and an electric drill 4. The apparatus includes a function adjusting gear box 106, and a rotary sleeve 102 fixed under and connected to the function adjusting gearbox. An upward standing pillar 103 of the stock 104 is linked with one end of the function changing, or function adjusting, cord 207. An opposite end of the function adjusting cord 207 is connected with the function adjusting shift fork 201. Between the function adjusting shift fork 201 and the outer shell of the function adjusting gear box 106 are installed reset springs 206. Function adjusting gear 202 is mounted on the main axle of the electric machine 203 and is movable thereon such that the function adjusting shift fork 201 can be inserted into the fork groove 210 of the function adjusting gears 202 to cause sliding of the function adjusting gear 202 along the main axle of the electric machine 203 and thereby cooperatively link with the transmission gears associated with each individual tool 2,3,4.

Transmission axle 209 of electric saw 3, transmission axle 402 of electric planer tool 2 and transmission axle 704 of electric drill 4 are disposed parallel to the main axle 203 of the apparatus. The transmission axle 209 of electric saw 3 has installed thereon the transmission gear 205 of electric saw 3, which coordinates with the function adjusting gear 202 through the transmission gear 204.

On the transmission axle of electric planer tool 402 is installed the transmission gear 401 of electric planer tool 2 which can match with the function adjusting gear 202. Also, the transmission axle 402 of electric planer tool 2 is joined with the transmission installation of the electric planer tool, and on the transmission axle 704 of electric drill 704 is fixed the transmission gear 701 of electric drill 4, which cooperates with the function adjusting gear 202. Furthermore, the transmission axle 704 of electric drill 2 is interconnected with the transmission installation of the electric drill.

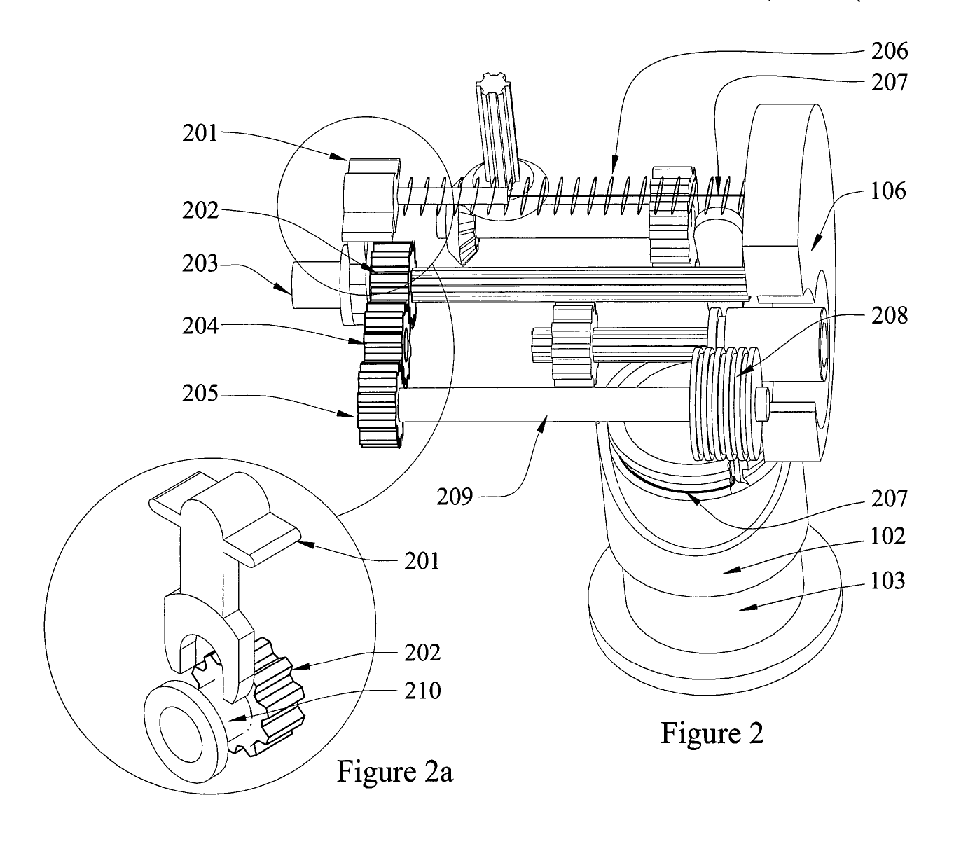

Referring particularly to FIGS. 1-2, in the case where the apparatus 101 will be used to saw wood, if only the electric saw blade 108 is set just against the groove 110 of the stock 104, the reset spring 206 will be in the condition of complete release. Then, the function adjusting shift fork 201 will push the function adjusting gear 202 to the electric saw transmission gear 204, and the apparatus 101 will power the transmission gear 205 of electric saw 3 through the main axle 203, the function adjusting gear 202 and the transmission gear 204, and the transmission axle 209 of the electric saw will also transfer the power to the electric saw through the transmission belt roller 208 of the electric saw 3 and the transmission belt 109. In this manner, the apparatus is able to function as a conventional electrical saw.

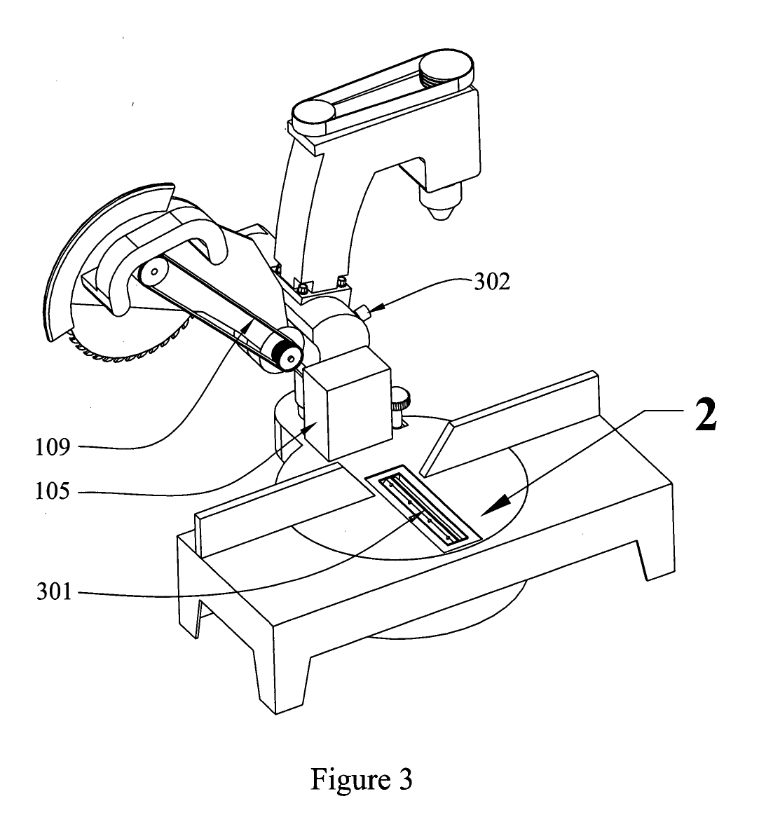

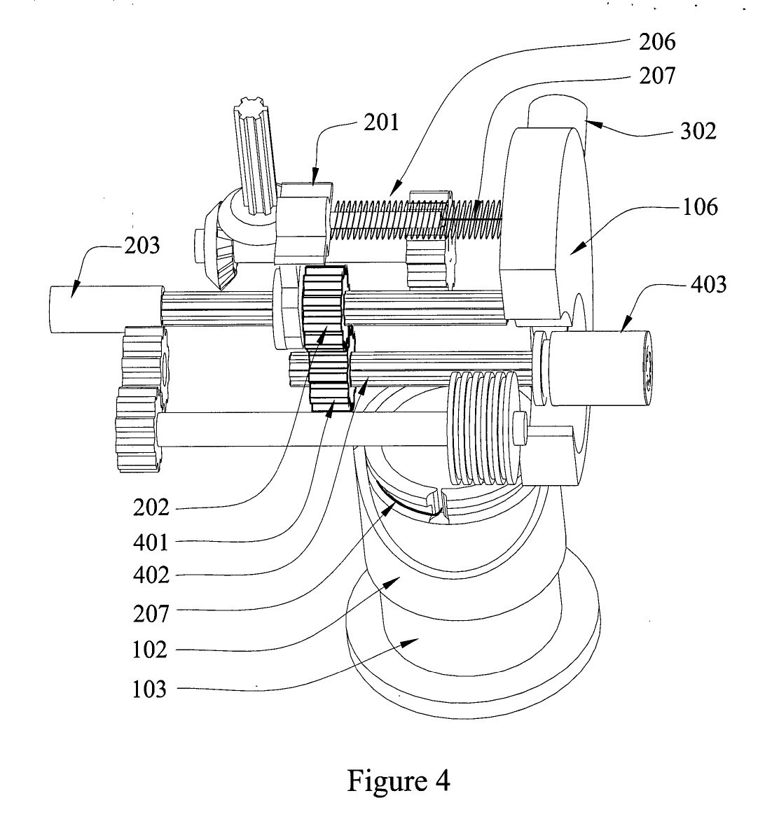

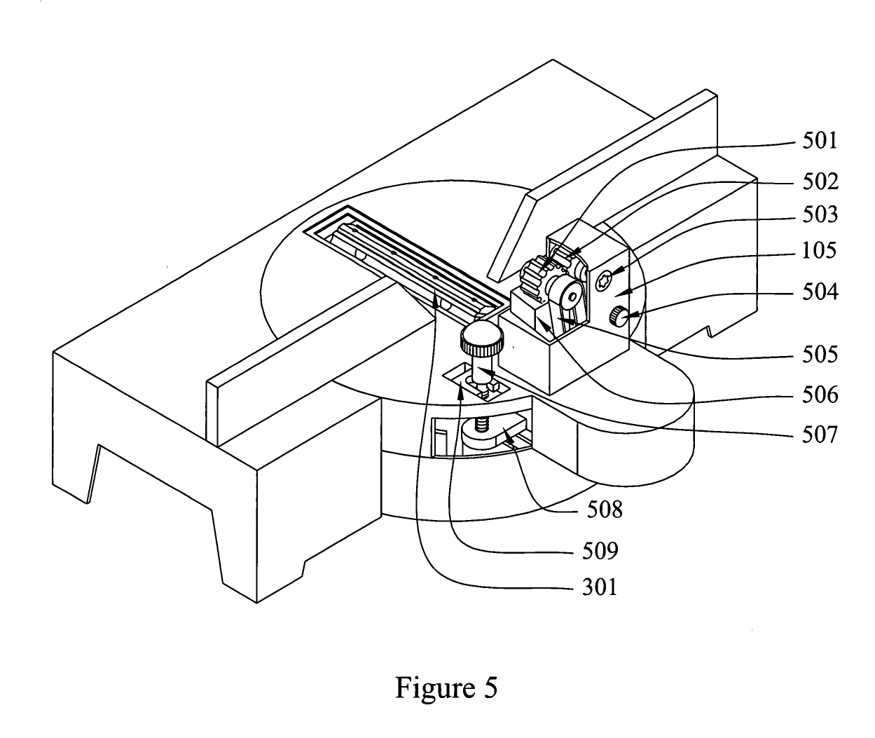

Referring particularly to FIGS. 3-5, where the apparatus 101 will be used to plane wood, the electric saw 3 is simply rotated by 90 degree in a clockwise direction. As result, the function adjusting gear box 106 engages the transmission gear box 105 of electric planer tool 2, the rotary sleeve 102 will rotate and, correspondingly, the function adjusting cord 207 will draw the function adjusting shift fork 201 to cause the function adjusting gear 202 to slide along the main axle 203 of the apparatus 101. In this manner, the function adjusting gear 202 will cooperate with the transmission gear 401 of electric planer tool 2, causing the transmission axle 402 of electric planer tool 2 to move.

Initially, screw 504 of electric planer tool 2 is loosened, anchorage handle 507 is pulled and lifted, thereby lifting the hobbing cutter of electric planer tool 2, which connects with the main slide arm 506. Then tighten the screw 504 of electric planer tool 2, push the anchorage locking chip 509 to the location of the lifting and anchorage handle 507 and, finally, tighten the lifting and anchorage handle 507.

Then, the powered clutch handle 302 of electric planer tool 2 is rotated so that the transmission clutch sleeve 403 can engage the axle receiving aperture 503, which causes the gear 502 part of the axle to rotate. The rotation of the gear 502 causes the belt roller 501 of electric planer tool 2 to rotate, and the belt roller 501, in turn, cause the hobbing cutter 301 of electric planer tool 2 operate through the transmission belt 505. In this manner, the apparatus is able to function as a conventional electrical planer tool.

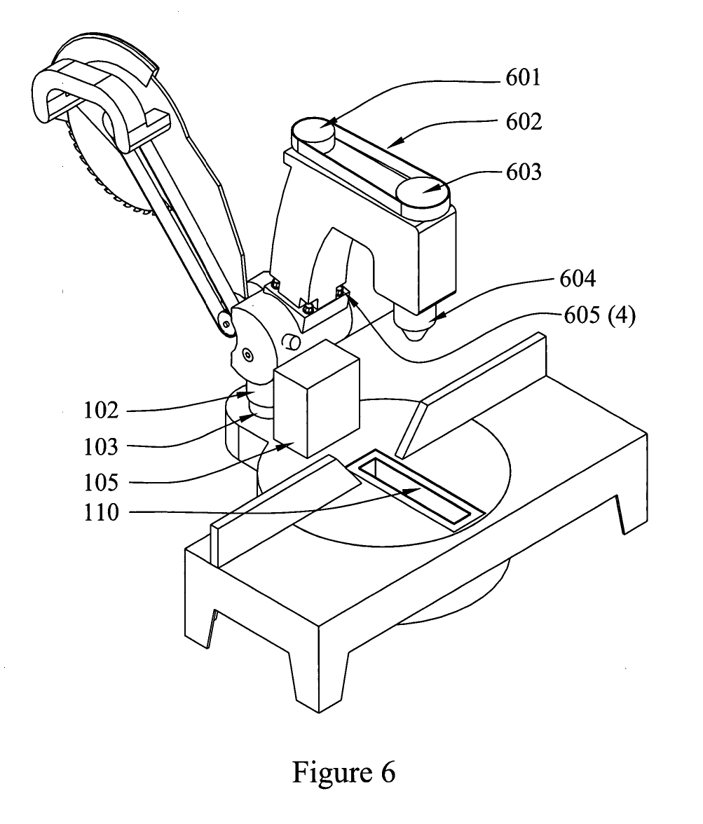

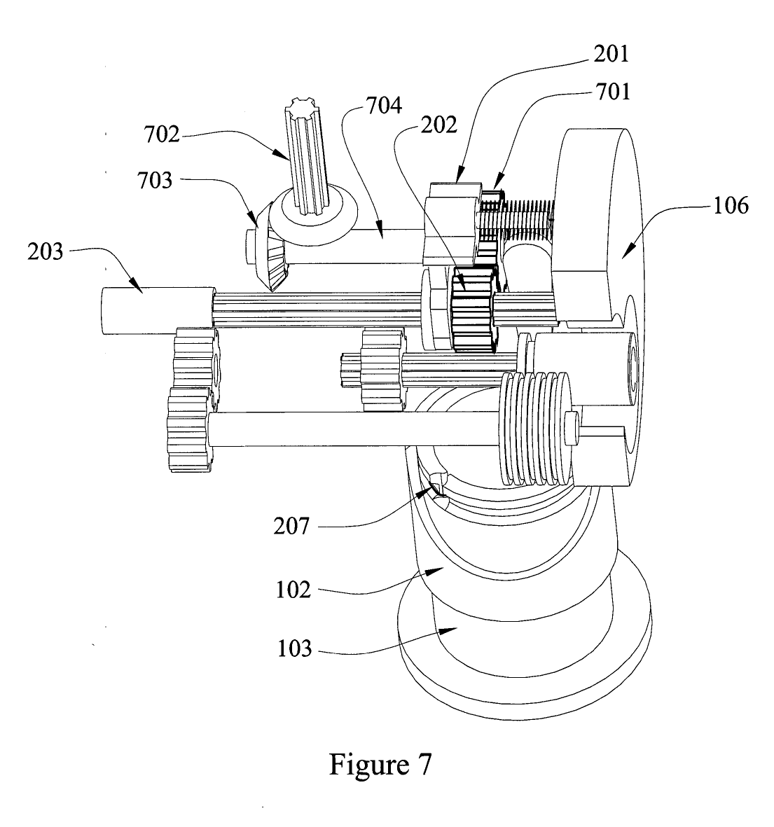

Referring now particularly to FIGS. 6-7, where the apparatus 101 will be used to drill or bore a hole in wood, the electric drill 4 is simply rotated so that the grip holder 604 of electric drill 4 is set just against the groove 110 of the stock 104, causing the rotary sleeve 102 to rotate, enabling the adjusting cord 207 to draw the function adjusting shift fork 201, and in turn push the function adjusting gear 202 in a sliding manner along the main axle 203 of the apparatus 101. In this fashion, the function adjusting gear 202 will engage with the transmission gear 701 of electric drill 4, causing the transmission axle 704 of electric drill 4 to rotate. At that point, electrical power is transferred to the grip holder 604, via the transmission bevel gear 703, transmission kingbolt 702, transmission belt 601, transmission belt 602 and the belt roller 603. In this manner, the apparatus functions as a conventional electric drill.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A multifunctional electrically powered construction apparatus, comprising:
a stock having an upward standing pillar extending therefrom;
an electric saw mounted upon said stock pillar;
an electric drill mounted upon said stock pillar;
an electric planer mounted upon said stock pillar; and
a cooperating system of gears and transmissions,
wherein, said cooperating system of gears and transmissions enable an operator of said apparatus to selectively toggle between operation of said saw, said drill and said planer.

2. A multifunctional electrically powered construction apparatus as recited in claim 1, further comprising:
a function adjustment cord; and
a function adjustment shift fork.

3. A multifunctional electrically powered construction apparatus as recited in claim 2, wherein said function adjustment cord has a first end engaging said upward standing pillar and a second end engaging said function adjustment shift fork.
